(19) United States
(12) Patent Application Publication
(10) Pub. No.: US 2024/0129491 A1
(43) Pub. Date: Apr. 18, 2024

(54) VIDEO ENCODING/DECODING METHOD AND APPARATUS

(71) Applicants: HYUNDAI MOTOR COMPANY, Seoul (KR); KIA CORPORATION, Seoul (KR)

(72) Inventors: Seung Wook Park, Yongin-si (KR); Jin Heo, Yongin-si (KR)

(73) Assignees: HYUNDAI MOTOR COMPANY, Seoul (KR); KIA CORPORATION, Seoul (KR)

(21) Appl. No.: 18/399,268

(22) Filed: Dec. 28, 2023

Related U.S. Application Data
(63) Continuation of application No. PCT/KR2022/009400, filed on Jun. 30, 2022.

(30) Foreign Application Priority Data
Jul. 1, 2021 (KR) 10-2021-0086267
Jun. 27, 2022 (KR) 10-2022-0078322

(51) Int. Cl. H04N 19/159; H04N 19/176

(52) U.S. Cl. CPC H04N 19/159; H04N 19/176

(57) ABSTRACT

A video encoding/decoding method and a video encoding/decoding device are provided. The video decoding method according to the present disclosure includes determining at least two intra prediction modes based on intra prediction modes of neighboring blocks adjacent to a current block. The video decoding method also includes deriving a most probable mode (MPM) list based on the at least two intra prediction modes. The video decoding method also includes deriving an intra prediction mode of the current block based on the MPM list. The video decoding method also includes generating a prediction block of the current block based on the intra prediction mode. Candidate modes in the MPM list can be configured using an intra prediction mode list generated based on the at least two intra prediction modes.

### CROSS-REFERENCE TO RELATED APPLICATIONS

This application is a Continuation of International Application No. PCT/KR2022/009400 filed on Jun. 30, 2022, which claims priority to Korean Patent Application No. 10-2021-0086267 filed on Jul. 1, 2021, and Korean Patent Application No. 10-2022-0078322 filed on Jun. 27, 2022, the entire disclosures of each of which are incorporated herein by reference.

### TECHNICAL FIELD

The present disclosure relates to a video encoding/decoding method and a video encoding/decoding apparatus. More particularly, the present disclosure relates to a video encoding/decoding method and a video encoding/decoding apparatus that generates histogram of mode (HoM) based on a combination of intra prediction modes of neighboring blocks adjacent to a current block and generates most probable mode (MPM) list from the HoM to derive an intra prediction mode of the current block.

### BACKGROUND

The contents described below simply provide background information related to the present embodiment and do not constitute prior art.

Since the volume of video data is larger than the volume of voice data or still image data, storing or transmitting video data without processing the video data by compression requires a lot of hardware resources including memory.

Accordingly, in storing or transmitting video data, the video data is generally compressed using an encoder so as to be stored or transmitted. Then, a decoder receives the compressed video data and decompresses and reproduces the video data. Compression techniques for such video include H.264/AVC, high efficiency video coding (HEVC), and versatile video coding (VVC), which improves coding efficiency by about 30% or more compared to HEVC.

However, the video size, resolution, and frame rate are gradually increasing, and thus the amount of data to be encoded is also increasing. Accordingly, a new compression technique having better encoding efficiency and higher image quality than the existing compression technique is required.

Intra prediction is a prediction technology that allows only spatial reference and refers to a method of predicting a current block by referring to blocks that have already been restored around a block for which encoding is currently being performed. In the case of intra prediction, an intra prediction mode of the current block may be derived using a most probable mode (MPM) list. The MPM list is generated based on the intra prediction mode of neighboring blocks adjacent to the current block. There is a need to reduce complexity and improve coding efficiency in relation to the creation of the MPM list.

### SUMMARY

An object of the present disclosure is to provide a method and an apparatus for deriving an intra prediction mode based on the intra prediction mode of neighboring blocks adjacent to a current block.

Another object of the present disclosure is to provide a method and an apparatus for generating a most probable mode (MPM) list based on offline training.

Another object of the present disclosure is to provide a method and an apparatus for generating a histogram of a mode based on offline training.

Another object of the present disclosure is to provide a method and an apparatus for classifying intra prediction modes into several groups and generating a histogram for a combination of the groups.

Another object of the present disclosure is to provide a method and an apparatus for generating an MPM list based on a generated histogram.

Another object of the present disclosure is to provide a method and an apparatus for generating an MPM list without using intra prediction mode information of neighboring blocks, when the MPM list is generated based on a histogram.

Another object of the present disclosure is to provide a method and an apparatus for generating an MPM list using intra prediction mode information of neighboring blocks, when the MPM list is generated based on a histogram.

Another object of the present disclosure is to provide a method and an apparatus for improving video encoding/decoding efficiency.

Another object of the present disclosure is to provide a recording medium that stores a bitstream generated by a video encoding/decoding method or a video encoding/decoding apparatus of the present disclosure.

Another object of the present disclosure is to provide a method and an apparatus for transmitting a bitstream generated by a video encoding/decoding method or an apparatus of the present disclosure.

According to a present disclosure, a video decoding method comprises determining at least two intra prediction modes based on intra prediction modes of neighboring blocks adjacent to a current block. The video decoding method also comprises deriving a most probable mode (MPM) list based on the at least two intra prediction modes. The video decoding method also comprises deriving an intra prediction mode of the current block based on the MPM list. The video decoding method also comprises generating a prediction block of the current block based on the intra prediction mode. Candidate modes in the MPM list are configured using an intra prediction mode list generated based on the at least two intra prediction modes.

In the video decoding method according to the present disclosure, wherein the at least two intra prediction modes are randomly selected from the intra prediction modes of the neighboring blocks adjacent to the current block.

In the video decoding method according to the present disclosure, wherein the at least two intra prediction modes are determined based on a frequency of occurrence of the intra prediction modes of the neighboring blocks adjacent to the current block.

In the video decoding method according to the present disclosure, wherein the intra prediction mode list is updated by increasing an occurrence frequency of a first intra prediction mode of the current block by one. The first intra prediction mode of the current block is derived based on offline training.

In the video decoding method according to the present disclosure, wherein the intra prediction mode list is generated based on a specific group to which the at least two intra prediction modes belong. The specific group is determined based on at least one of a specific number and specific direction of the intra prediction modes.

In the video decoding method according to the present disclosure, wherein the candidate modes in the MPM list are configured in an order of a planar mode, the at least two intra prediction modes, and intra prediction modes with a high frequency of occurrence in the intra prediction mode list.

In the video decoding method according to the present disclosure, wherein the candidate modes in the MPM list are configured in an order of the at least two intra prediction modes and intra prediction modes with a high frequency of occurrence in the intra prediction mode list.

In the video decoding method according to the present disclosure, wherein the candidate modes in the MPM list are configured in an order of a planar mode and intra prediction modes with a high frequency of occurrence in the intra prediction mode list.

In the video decoding method according to the present disclosure, wherein the candidate modes in the MPM list are configured in an order of the intra prediction modes with a high frequency of occurrence in the intra prediction mode list.

In the video decoding method according to the present disclosure, wherein the candidate modes in the MPM list include intra prediction modes in a default mode set based on the candidate modes in the MPM list not being filled. The default mode set includes arbitrary intra prediction modes.

According to the present disclosure, a video encoding method comprises determining at least two intra prediction modes based on intra prediction modes of neighboring blocks adjacent to a current block. The video encoding method also comprises determining a most probable mode (MPM) list based on the at least two intra prediction modes. The video encoding method also comprises determining an intra prediction mode of the current block based on the MPM list. The video encoding method also comprises generating a prediction block of the current block based on the intra prediction mode. Candidate modes in the MPM list are configured using an intra prediction mode list generated based on the at least two intra prediction modes.

In the video encoding method according to the present disclosure, the at least two intra prediction modes are randomly selected from the intra prediction modes of the neighboring blocks adjacent to the current block.

In the video encoding method according to the present disclosure, the at least two intra prediction modes are determined based on a frequency of occurrence of the intra prediction modes of the neighboring blocks adjacent to the current block.

In the video encoding method according to the present disclosure, the intra prediction mode list is updated by increasing an occurrence frequency of a first intra prediction mode of the current block by one. The first intra prediction mode of the current block is derived based on offline training.

In the video encoding method according to the present disclosure, the intra prediction mode list is generated based on a specific group to which the at least two intra prediction modes belong. The specific group is determined based on at least one of a specific number and specific direction of the intra prediction modes.

In the video encoding method according to the present disclosure, the candidate modes in the MPM list are configured in an order of a planar mode, the at least two intra prediction modes, and intra prediction modes with a high frequency of occurrence in the intra prediction mode list.

In the video encoding method according to the present disclosure, the candidate modes in the MPM list are configured in an order of the at least two intra prediction modes and intra prediction modes with a high frequency of occurrence in the intra prediction mode list.

In the video encoding method according to the present disclosure, the candidate modes in the MPM list are configured in an order of a planar mode and intra prediction modes with a high frequency of occurrence in the intra prediction mode list.

In the video encoding method according to the present disclosure, the candidate modes in the MPM list are configured in an order of the intra prediction modes with a high frequency of occurrence in the intra prediction mode list.

In the video encoding method according to the present disclosure, the candidate modes in the MPM list include intra prediction modes in a default mode set based on the candidate modes in the MPM list not being filled. The default mode set includes arbitrary intra prediction modes.

In addition, according to the present disclosure, it is possible to provide a method of transmitting a bitstream generated by the video encoding method or the video encoding apparatus according to the present disclosure.

In addition, according to the present disclosure, it is possible to provide a recording medium storing a bitstream generated by the video encoding method or the video encoding apparatus according to the present disclosure.

In addition, according to the present disclosure, it is possible to provide a recording medium storing a bitstream received and decoded by the video decoding apparatus according to the present disclosure and used to reconstruct a video.

According to the present disclosure, the method and an apparatus for deriving an intra prediction mode based on the intra prediction mode of neighboring blocks adjacent to a current block may be provided.

In addition, according to the present disclosure, the method and an apparatus for generating a most probable mode (MPM) list based on offline training may be provided.

In addition, according to the present disclosure, the method and an apparatus for generating a histogram of a mode based on offline training may be provided.

In addition, according to the present disclosure, the method and an apparatus for classifying intra prediction modes into several groups and generating a histogram for a combination of the groups may be provided.

In addition, according to the present disclosure, the method and an apparatus for generating an MPM list based on a generated histogram may be provided.

In addition, according to the present disclosure, the method and an apparatus for generating an MPM list without using intra prediction mode information of neighboring blocks when the MPM list is generated based on a histogram may be provided.

In addition, according to the present disclosure, the method and an apparatus for generating an MPM list using intra prediction mode information of neighboring blocks when the MPM list is generated based on a histogram may be provided.

In addition, according to the present disclosure, the method and an apparatus for improving video encoding/decoding efficiency may be provided.

The effects that may be obtained from the present disclosure are not limited to the effects mentioned above, and other effects not mentioned may be clearly understood by those having ordinary skill in the art from the description below.

### BRIEF DESCRIPTION OF DRAWINGS

FIG. 1 is a block diagram of a video encoding apparatus that may implement a technology of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement technologies of the present disclosure.

FIG. 6 is a diagram illustrating an intra prediction mode, according to an embodiment of the present disclosure.

FIG. 7 is a diagram illustrating neighboring blocks adjacent to a current block, according to an embodiment of the present disclosure.

FIG. 8 is a diagram illustrating a most probable mode (MPM) list generating process, according to an embodiment of the present disclosure.

FIG. 9 is a diagram illustrating a method of configuring an MPM list according to an MPM list generating method, according to an embodiment of the present disclosure.

FIG. 10 is a diagram illustrating a method of generating an MPM list based on offline training, according to an embodiment of the present disclosure.

FIG. 11 is a diagram illustrating a method of generating a histogram of a mode based on offline training, according to an embodiment of the present disclosure.

FIG. 12 is a diagram illustrating a method of mapping intra prediction modes to specific groups, according to an embodiment of the present disclosure.

FIG. 13 is a diagram illustrating a method of generating an MPM list using a histogram of a mode, according to an embodiment of the present disclosure.

FIG. 14 is a diagram illustrating a method of generating an MPM list using a histogram of a mode according to another embodiment of the present disclosure.

FIG. 15 is a diagram illustrating a video decoding process, according to an embodiment of the present disclosure.

FIG. 16 is a diagram illustrating a video encoding process according to an embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure have been omitted for the purpose of clarity and for brevity.

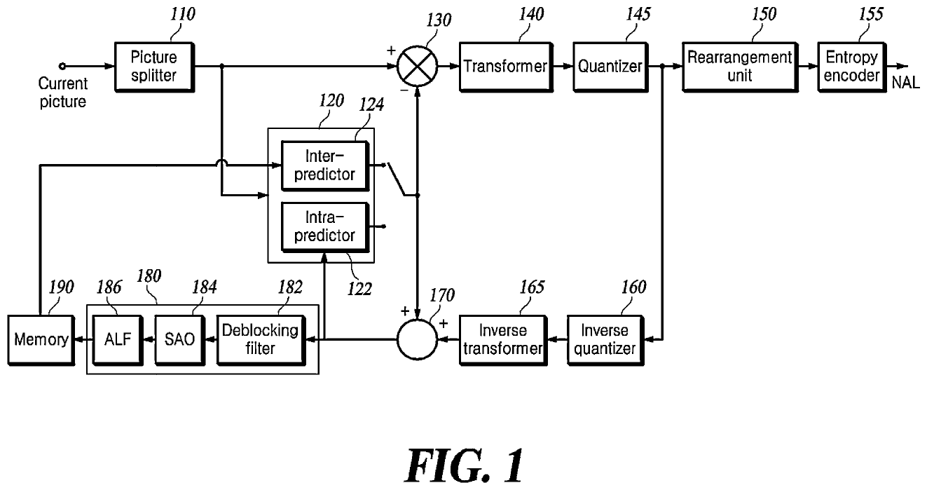

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each CU is encoded as a syntax of the CU and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a BTTT is added to the tree structures to be referred to as a multiple-type tree (MTT).

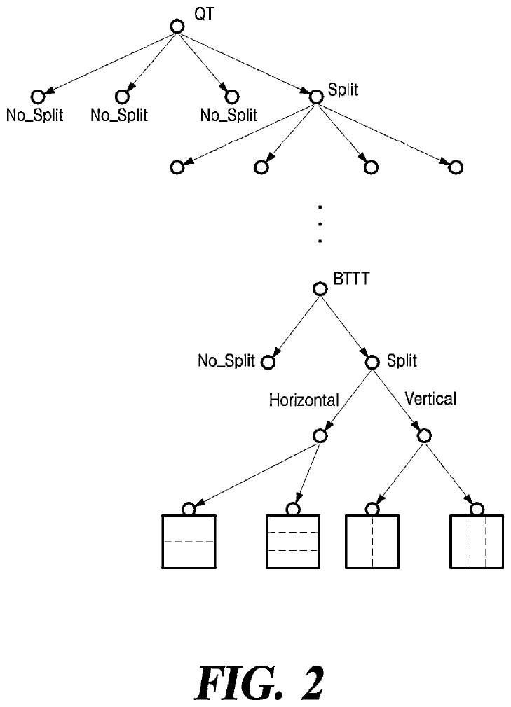

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks of a form of being asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block”. As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

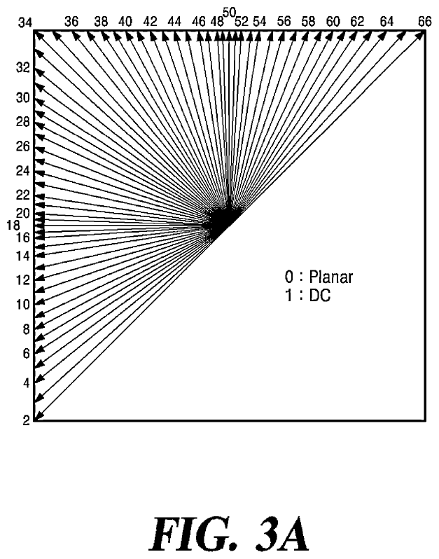

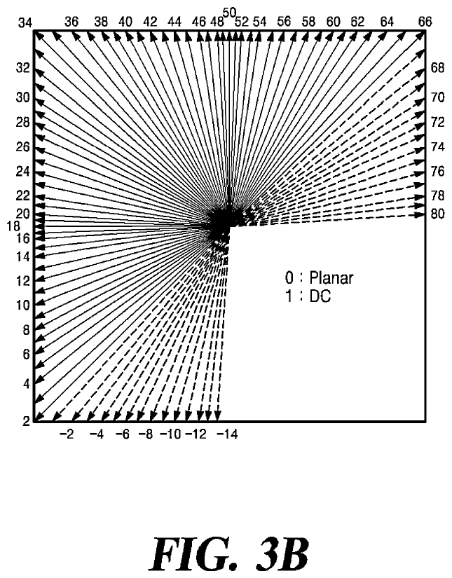

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction. The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and also select an appropriate intra prediction mode to be used from tested modes. For example, the intra predictor 122 may calculate rate-distortion values by using a rate-distortion analysis for multiple tested intra prediction modes and also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current bock in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, etc. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

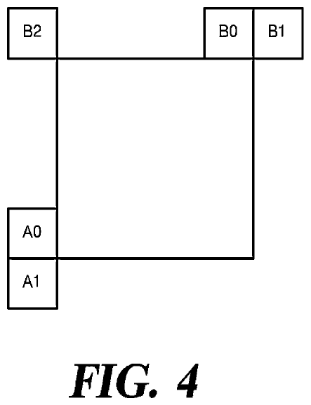

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be obtained by applying a pre-defined function (e.g., center value and average value computation, etc.) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

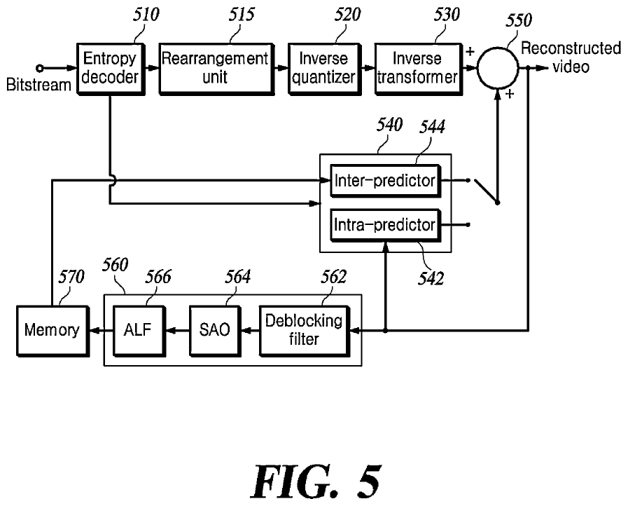

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for restoring the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT being further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by restoring the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

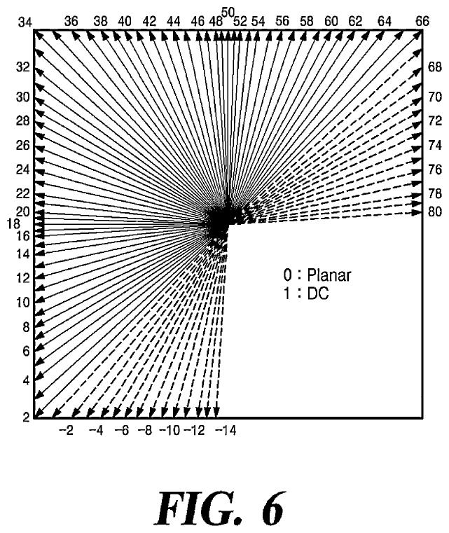

FIG. 6 is a diagram illustrating an intra prediction mode according to an embodiment of the present disclosure. In-picture prediction mode and intra prediction mode may have the same meaning. Intra prediction modes of versatile video coding (VVC) include 65 directional modes, two non-directional modes, and 28 wide-angle directional modes. Intra prediction modes of VVC supports a total of 95 intra prediction modes. In VVC, many intra prediction modes may be used to generate a prediction block of a current block with detailed directionality. Accordingly, many bits may be used to encode intra prediction mode information.

Referring to FIG. 6, non-directional modes, such as a DC mode and a planar mode, may exist. Directional modes, which are angular2 to angular66, may exist. The other modes may correspond to wide-angle directional modes.

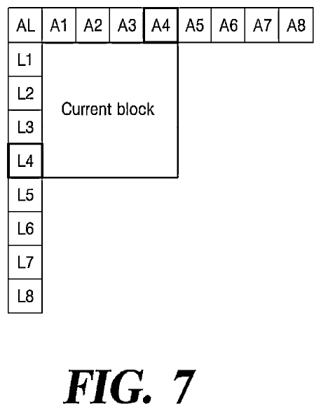

FIG. 7 is a diagram illustrating neighboring blocks adjacent to the current block, according to an embodiment of the present disclosure. In intra prediction, the current block and neighboring blocks adjacent to the current block may be similar to each other. Accordingly, the intra prediction mode of the current block and the intra prediction mode of neighboring blocks adjacent to the current block may be the same or similar to each other. The most probable mode (MPM) may allocate a small number of bits to the intra prediction mode of a neighboring block that is the same or similar to the intra prediction mode of the current block using the similarity. Accordingly, the number of bits required for encoding intra prediction mode information may be reduced. In VVC, the MPM list may include six candidate modes. The MPM list may be configured according to the intra prediction mode of a neighboring block adjacent to the left of the current block and the intra prediction mode of a neighboring block adjacent to the upper side of the current block.

Referring to FIG. 7, neighboring blocks A1 to A4 adjacent to the top of the current block may exist. Neighboring blocks A5 to A8 adjacent to the top right of the current block may exist. A neighboring block AL adjacent to the top left of the current block may exist. Neighboring blocks L1 to L4 adjacent to the left of the current block may exist. Neighboring blocks L5 to L8 adjacent to the bottom left of the current block may exist. To generate an MPM list, the neighboring blocks adjacent to the top of the current block and neighboring blocks adjacent to the left of the current block may be used. As an example, the MPM list may be generated using the neighboring block L4 adjacent to the left of the current block and the neighboring block A4 adjacent to the top of the current block. However, the present disclosure is not limited to these embodiments. Any two neighboring blocks adjacent to the current block may be used to generate the MPM list.

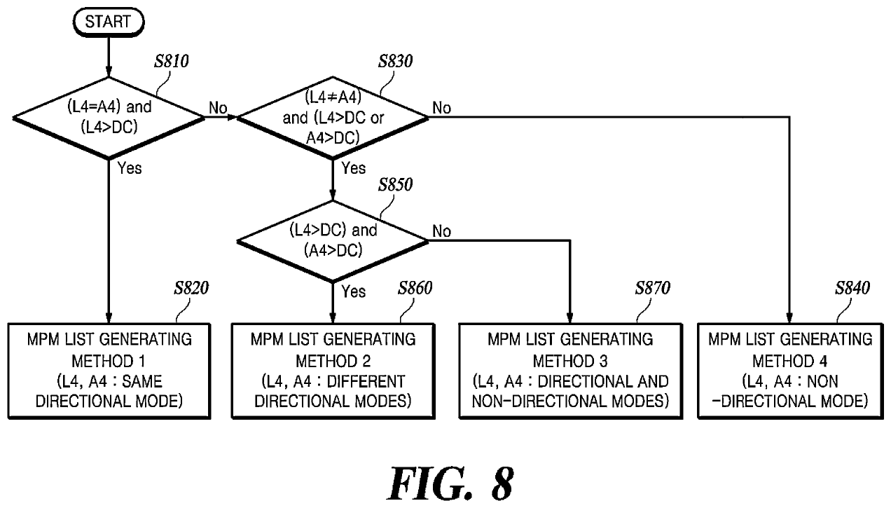

FIG. 8 is a diagram illustrating an MPM list generating process according to an embodiment of the present disclosure. An MPM list may be generated using the neighboring block L4 adjacent to the left of the current block in FIG. 7 and the neighboring block A4 adjacent to the top of the current block. The L4 mode may correspond to the intra prediction mode of the neighboring block L4. The A4 mode may correspond to the intra prediction mode of the neighboring block A4.

Referring to FIG. 8, it may be determined whether the L4 mode and the A4 mode are the same and whether the L4 mode is a directional mode (S810). If the L4 mode and the A4 mode are the same and the L4 mode is a directional mode (S810-YES), an MPM list may be generated according to MPM list generating method 1 (S820). Here, the L4 mode and the A4 mode may correspond to the same directional modes. Also, if the L4 mode and the A4 mode are not the same or the L4 mode is not a directional mode (S810-NO), it may be determined whether the L4 mode and the A4 mode are different and whether the L4 mode or the A4 mode is a directional mode (S830). If the L4 mode and the A4 mode are the same or if the L4 mode or the A4 mode is not a directional mode (S830-NO), an MPM list may be generated according to MPM list generating method 4 (S840). Here, the L4 mode and the A4 mode may correspond to the same non-directional mode. Alternatively, the L4 mode and the A4 mode may correspond to different non-directional modes. If the L4 mode and the A4 mode are different and the L4 mode or the A4 mode is a directional mode (S830-YES), it may be determined whether the L4 mode is a directional mode and the A4 mode is a directional mode (S850). If the L4 mode is a directional mode and the A4 mode is a directional mode (S850-YES), an MPM list may be generated according to MPM list generating method 2 (S860). Here, the L4 mode and the A4 mode may correspond to different directional modes. If a non-directional mode exists among the L4 mode or A4 mode (S850-NO), an MPM list may be generated according to MPM list generating method 3 (S870). Here, the L4 mode may correspond to a directional mode and the A4 mode may correspond to a non-directional mode. Alternatively, the L4 mode may correspond to a non-directional mode and the A4 mode may correspond to a directional mode.

The MPM list generating process described above with reference to FIG. 8 is an example, and the MPM list generating process according to the present disclosure is not limited to the example shown in FIG. 8. For example, some of the steps shown in FIG. 8 may be omitted, and steps other than those shown in FIG. 8 may be added at any position in the flowchart of FIG. 8. In addition, some of the steps shown in FIG. 8 may be performed simultaneously with other steps or an order thereof may be changed from other steps.

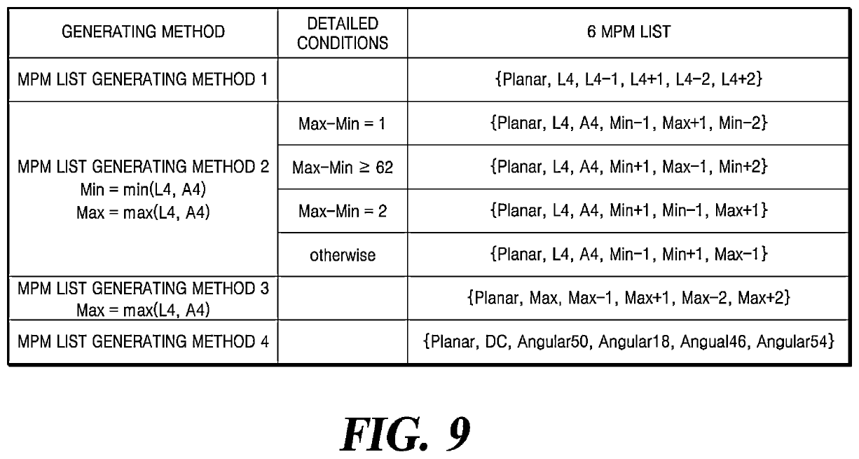

FIG. 9 is a diagram illustrating a method of configuring an MPM list according to an MPM list generating method according to an embodiment of the present disclosure. An MPM list may be generated using the neighboring block L4 adjacent to the left of the current block in FIG. 7 and the neighboring block A4 adjacent to the top of the current block in FIG. 7. The L4 mode may correspond to the intra prediction mode of the neighboring block L4. The A4 mode may correspond to the intra prediction mode of the neighboring block A4.

Referring to FIG. 9, an MPM list may be generated according to the MPM list generating methods 1, 2, 3, and 4. Each generated MPM list may include six candidate modes. Max may refer to a larger mode among the L4 mode and the A4 mode. Min may refer to a smaller mode among the L4 mode and the A4 mode. Adding −1, +1, −2, or +2 to a specific mode may refer to a mode that is one smaller, one larger, two smaller, or two larger than the specific mode, respectively. Angular50, Angular18, Angular46, and Angular54 may refer to directional mode 50, directional mode 18, directional mode 46, and directional mode 54, respectively. In the case of MPM list generating method 1, the L4 mode and the A4 mode may correspond to the same directional mode. An MPM list including six candidate modes may be generated according to MPM list generating method 1.

In the case of MPM list generating method 2, the L4 mode and the A4 mode may correspond to different directional modes. In the case of MPM list generating method 2, the generated MPM list may be classified into four detailed conditions depending on the relationship between the L4 mode and the A4 mode. According to these four detailed conditions, an MPM list including six candidate modes may be generated. In the case of MPM list generating method 3, the L4 mode may correspond to a directional mode and the A4 mode may correspond to a non-directional mode. Alternatively, the L4 mode may correspond to a non-directional mode and the A4 mode may correspond to a directional mode. According to MPM list generating method 3, an MPM list including six candidate modes may be generated. In the case of MPM list generating method 4, the L4 mode and the A4 mode may correspond to the same non-directional mode. Alternatively, the L4 mode and the A4 mode may correspond to different non-directional modes. According to MPM list generating method 4, an MPM list including six candidate modes may be generated.

According to the MPM list generating method according to FIG. 9, an MPM list may be configured to be biased to the L4 mode and the A4 mode. According to the MPM list generating method according to FIG. 9, the MPM list generating method is classified according to various conditions and detailed conditions, and a MPM list candidate mode may be calculated through a modular operation. Accordingly, coding efficiency may decrease and complexity may increase.

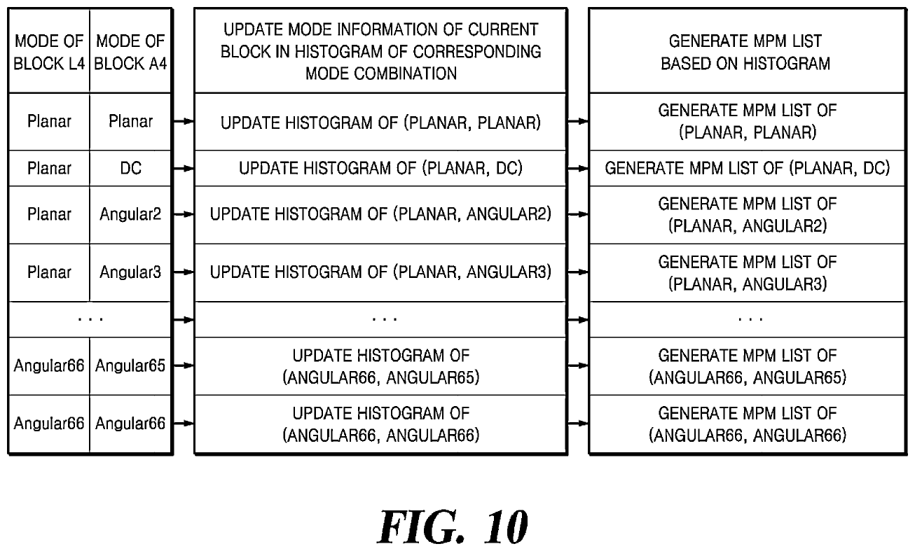

FIG. 10 is a diagram illustrating a method of generating an MPM list based on offline training, according to an embodiment of the present disclosure. An MPM list may be generated using the neighboring block L4 adjacent to the left of the current block in FIG. 7 and the neighboring block A4 adjacent to the top of the current block in FIG. 7. The L4 mode may correspond to the intra prediction mode of the neighboring block L4. A4 mode may correspond to the intra prediction mode of the neighboring block A4. Through offline training, a histogram may be generated based on the L4 mode, the A4 mode, and the intra prediction mode of the current block. An optimal MPM list may be generated using the histogram.

Referring to FIG. 10, a histogram may be generated according to a combination of the L4 mode and the A4 mode. The corresponding histogram may be updated by considering the optimal intra prediction mode of the current block in the histogram. The optimal intra prediction mode for the current block may be determined through offline training. In offline training, the optimal intra prediction mode of the current block may be determined using the MPM list configured according to FIG. 9. An MPM list may be generated based on the updated histogram. For example, if the L4 mode is the planar mode and the A4 mode is Angular20, a histogram for the combination of (Planar, Angular20) may be generated. If the optimal intra prediction mode for the current block determined through offline training is Angular50, the histogram for the combination of (Planar, Angular20) may be updated by considering Angular50. An MPM list for the combination of (Planar, Angular20) may be generated by selecting a high-priority mode from the updated histogram. The high-priority mode may correspond to a mode with a high frequency of occurrence within the histogram. The MPM list generating process may be performed during a bitstream parsing process and may be performed offline rather than in real time. However, the present disclosure is not limited to these embodiments.

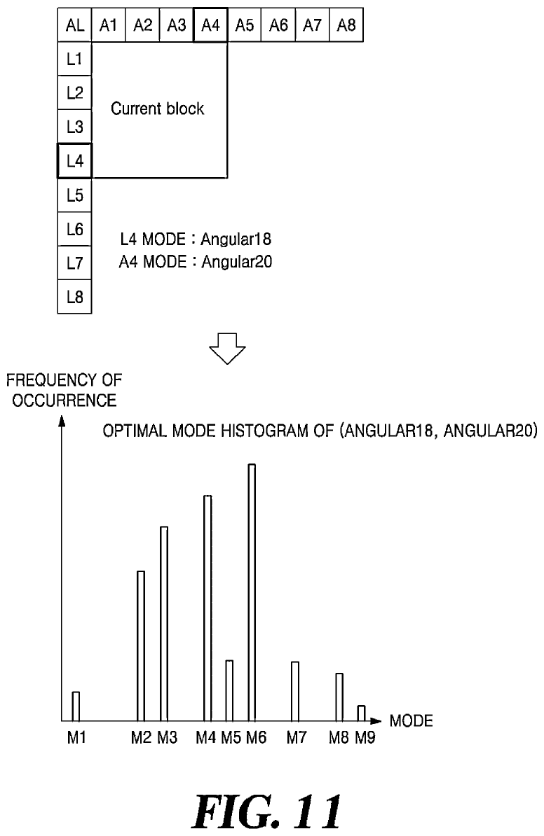

FIG. 11 is a diagram illustrating a method of generating a histogram of a mode based on offline training, according to an embodiment of the present disclosure.

Referring to FIG. 11, the L4 mode and the A4 mode may correspond to Angular18 and Angular20, respectively. Accordingly, a histogram for a combination of (Angular18, Angular20) may be generated. If the intra prediction mode of the current block determined through offline training is Angular53, the histogram may be updated by increasing the frequency of occurrence of Angular53 by one in the histogram for the combination of (Angular18, Angular20). M1 to M9 in the histogram may correspond to any intra prediction mode.

In addition to generating a histogram for a combination of the L4 mode and the A4 mode, a histogram may be generated in another way. Based on the frequency of occurrence of intra prediction modes of neighboring blocks adjacent to the current block, two intra prediction modes with the highest frequency of occurrence may be selected. A histogram may be generated for a combination of the two selected intra prediction modes. For example, the frequency of occurrence of intra prediction modes of the blocks L1 to L8, the block AL, and the blocks A1 to A8 may be measured, and two intra prediction modes with the highest frequency of occurrence may be selected. A histogram may be generated for a combination of the two selected intra prediction modes. For example, one mode with the highest frequency of occurrence may be selected among the intra prediction modes of the blocks L1 to L8, and one mode with the highest frequency of occurrence may be selected from among the intra prediction modes of the blocks A1 to A8. In this manner, a histogram for the combination of the two selected intra prediction modes may be generated. However, the present disclosure is not limited to these embodiments. A histogram may be generated by randomly determining the position and number of neighboring blocks adjacent to the current block.

According to the histogram generating method of FIG. 11, the number of intra prediction modes, which are directional modes and non-directional modes in VVC, is 67, and thus, a histogram for a total of 67×67 combinations may be generated.

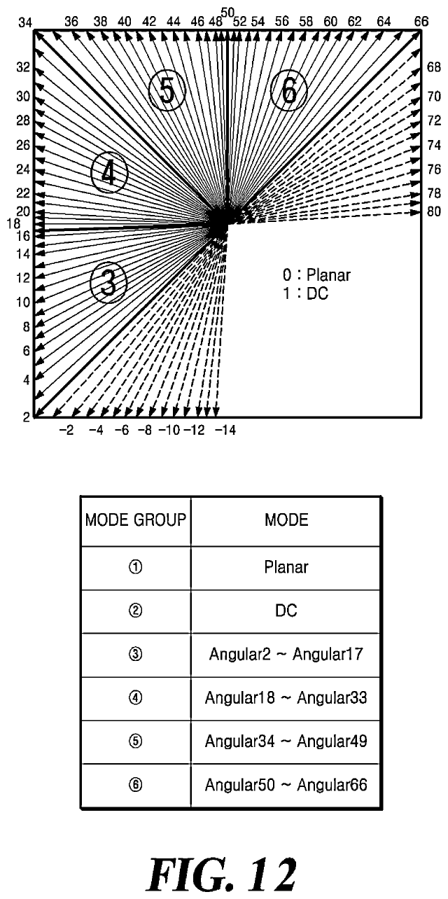

FIG. 12 is a diagram illustrating a method of mapping an intra prediction mode to a specific group according to an embodiment of the present disclosure. According to the histogram generating method of FIG. 11, a histogram for a total of 67×67 combinations may be generated. Accordingly, in order to reduce the size of memory, intra prediction modes may be classified into several groups and a histogram for the combination of the groups may be generated. Intra prediction modes may be classified into one group according to a specific number or specific direction. Since it is a combination of groups of intra prediction modes rather than a combination of intra prediction modes, the size of the memory may be reduced. Referring to FIG. 12, Planar mode may be assigned to group 1, DC mode may be assigned to group 2, Angular2˜Angular17 mode may be assigned to group 3, Angular18˜Angular33 mode may be assigned to group 4, Angular34˜Angular49 mode may be assigned to group 5, and angular50˜Angular66 modes may be assigned to group 6. For example, if the L4 mode belongs to group 1 and the A4 mode belongs to group 4, a histogram for a combination of group 1 and group 4 may be generated. The histogram for the combination of groups 1 and 4 may be updated by considering the intra prediction mode of the current block determined through offline training. For example, when two intra prediction modes with the highest frequency of occurrence are selected by considering the frequency of occurrence of intra prediction modes in neighboring blocks adjacent to the current block, the two selected intra prediction modes may belong to groups 1 and 4, respectively. Accordingly, a histogram for a combination of group 1 and group 4 may be generated. The histogram for the combination of groups 1 and 4 may be updated by considering the intra prediction mode of the current block determined through offline training. However, the present disclosure is not limited to these embodiments. The number of classified groups may correspond to an arbitrary number, and the number of intra prediction modes belonging to the classified group may also correspond to an arbitrary number. The method of mapping intra prediction modes to classified groups may also be arbitrarily determined.

In the case of generating a histogram as a combination of groups by classifying the intra prediction modes into several groups, the number of combinations may decrease. For example, when the intra prediction modes are classified into 6 groups, a histogram for a total of 6×6 combinations may be generated. By reducing the number of combinations, the size of memory for storing the MPM list may be reduced.

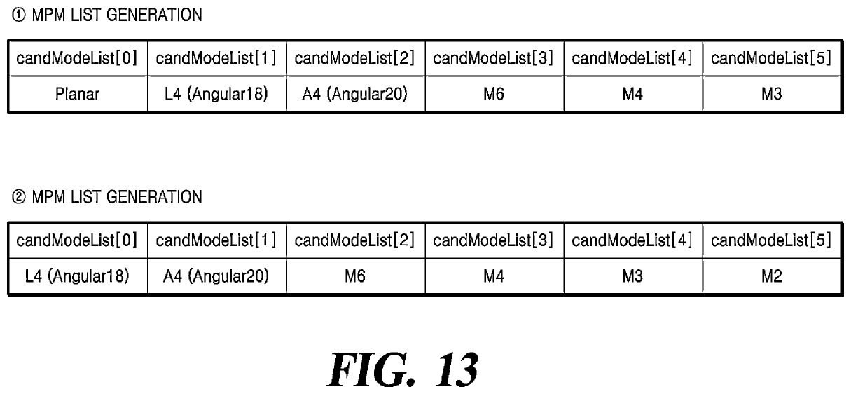

FIG. 13 is a diagram illustrating a method of generating an MPM list using a histogram of a mode, according to an embodiment of the present disclosure. A histogram of a combination may be generated based on the intra prediction mode of neighboring blocks adjacent to the current block, and an MPM list may be generated using the generated histogram. Here, when generating an MPM list, the MPM list may be generated using the intra prediction mode of the neighboring block.

Referring to FIG. 13, when an MPM list is generated, the intra prediction mode of a neighboring block may be added to the MPM list and an intra prediction mode with a high frequency of occurrence in the histogram may be added to the MPM list. The MPM list may include six candidate modes. The L4 mode may correspond to Angular18 mode and the A4 mode may correspond to Angular20 mode. In embodiment 1, the planar mode, which is a default mode, may be added to the MPM list, and Angular18 mode, which is the L4 mode, and Angular20 mode, which is the A4 mode, may be added. Here, Angular18 mode, which is the L4 mode, and Angular20 mode, which is the A4 mode, may be added to the MPM list in any order. Thereafter, the M6, M4, and M3 modes with the highest frequency of occurrence in the histogram of (Angular18, Angular20) combination may be added sequentially. In embodiment 2, Angular18 mode, which is the L4 mode, and Angular20 mode, which is the A4 mode, may be added to the MPM list without considering the planar mode, which is a default mode. Here, Angular18 mode, which is the L4 mode, and Angular20 mode, which is the A4 mode, may be added to the MPM list in any order. Thereafter, the modes M6, M4, M3, and M2 with the highest frequency of occurrence in the histogram of the (Angular18, Angular20) combination may be added sequentially. If the mode to be currently added from the histogram already exists in the MPM list, the corresponding mode may not be added to the MPM list. However, the present disclosure is not limited to these embodiments.

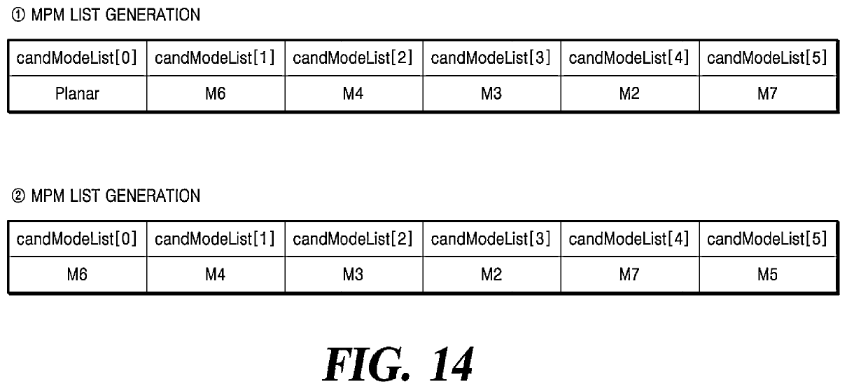

FIG. 14 is a diagram illustrating a method of generating an MPM list using a histogram of a mode according to another embodiment of the present disclosure. A histogram of a combination may be generated based on the intra prediction mode of neighboring blocks adjacent to the current block, and an MPM list may be generated using the generated histogram. Here, in the case of generating an MPM list, the MPM list may be generated without using the intra prediction mode of neighboring blocks.

Referring to FIG. 14, when generating an MPM list, an intra prediction mode with a high frequency of occurrence in the histogram may be added to the MPM list without considering the intra prediction mode of neighboring blocks. The MPM list may include six candidate modes. The L4 mode may correspond to Angular18 mode and the A4 mode may correspond to Angular20 mode. In embodiment 1, the planar mode, which is a default mode, may be added to the MPM list. Thereafter, the modes M6, M4, M3, M2, and M7 with the highest frequency of occurrence in the histogram of the (Angular18, Angular20) combination may be added sequentially. In embodiment 2, the modes M6, M4, M3, M2, M7, and M5 with the highest frequency of occurrence in the histogram of the combination (Angular18, Angular20) may be sequentially added without considering the planar mode, which is a default mode. If the mode to be currently added from the histogram is the planar mode and if the planar mode is already added as a default mode in the MPM list, the planar mode may not be added to the MPM list. However, the present disclosure is not limited to these embodiments.

If intra prediction modes with the same frequency of occurrence exist in the histogram, priority may be randomly assigned considering the number of the intra prediction mode. If all candidate modes in the MPM list are not filled, redundancy is checked from a predetermined default mode set, and an intra prediction mode in the default mode set may be added to the MPM list. As an example, the default mode set may include six intra prediction modes. The default mode set may include the planar mode, the DC mode, the Angular50 mode, the Angular18 mode, the Angular46 mode, and the Angular54 mode. However, the present disclosure is not limited to these embodiments. The number of intra prediction modes in the default mode set and the intra prediction mode may be arbitrarily determined.

The histogram-based MPM list generating method according to the present disclosure based on images may have various limitations. For example, if an offline trained image is a natural image and a test image is a computer graphics image or a synthetic image, a performance degradation may occur in the entire sequence, a specific picture, a specific slice, or a specific coding unit (CU) block. Accordingly, the histogram-based MPM list generating method according to the present disclosure may be designed to be performed at a sequence level, picture level, slice level, CTU (Coding Tree Unit) level, or a CU level.

An MPM list for the combination described above may be generated and the optimal MPM list may be stored in memory. This combination may be determined by considering the intra prediction mode of a neighboring block adjacent to the current block or the frequency of occurrence of intra prediction modes of neighboring blocks. The MPM list for the corresponding combination may be selected from the memory. The selected MPM list may be determined as the MPM list for the current block. Using the determined MPM list, the intra prediction mode of the current block may be derived and a prediction block of the current block may be generated. In the process of parsing an encoded bitstream, a process of updating the histogram of the combination may be performed using the intra prediction mode of the current block determined through offline training. After the process of parsing the bitstream is completed, an MPM list for each combination may be generated based on the histogram generated for all combinations. This process may be performed for all training sets and an optimal MPM list for each combination may be generated. The MPM list for all generated combinations may be stored in the memory. In the case of performing intra prediction, an MPM list may be selected from the memory and used. According to the present disclosure, the MPM list generating method based on offline training may be applied differently depending on the sequence, quantization parameter (QP), block size, or block type.

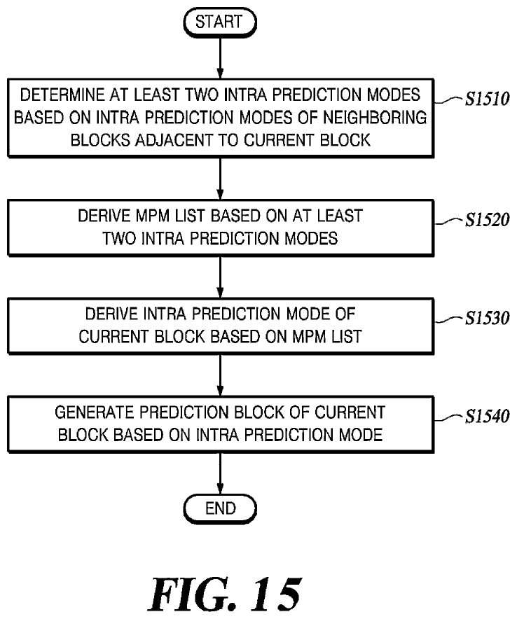

FIG. 15 is a diagram illustrating a video decoding process according to an embodiment of the present disclosure.

Referring to FIG. 15, a decoding apparatus may determine at least two intra prediction modes based on the intra prediction modes of neighboring blocks adjacent to the current block (S1510). At least two intra prediction modes may be randomly selected from the intra prediction modes of neighboring blocks adjacent to the current block. At least two intra prediction modes may be determined based on a frequency of occurrence of intra prediction modes of neighboring blocks adjacent to the current block. Also, the decoding apparatus may derive the MPM list based on at least two intra prediction modes (S1520). Candidate modes in the MPM list may be configured using an intra prediction mode list generated based on at least two intra prediction modes. The intra prediction mode list may be updated by increasing an occurrence frequency of a first intra prediction mode of the current block by one. The first intra prediction mode of the current block may be derived based on offline training. The intra prediction mode list may be generated based on a specific group to which at least two intra prediction modes belong, and the specific group may be determined based on at least one of a specific number and a specific direction of intra prediction modes.

Also, the decoding apparatus may derive the intra prediction mode of the current block based on the MPM list (S1530). Also, the decoding apparatus may generate a prediction block of the current block based on the intra prediction mode (S1540). The candidate modes in the MPM list may include a planar mode, at least two intra prediction modes, and an intra prediction mode with a high frequency of occurrence in the intra prediction mode list. The candidate modes in the MPM list may include at least two intra prediction modes and an intra prediction mode with a high frequency of occurrence in the intra prediction mode list. The candidate modes in the MPM list may be configured in the order of the planar mode and the intra prediction mode with high frequency of occurrence in the intra prediction mode list. The candidate modes in the MPM list may be configured in the order of intra prediction modes with high frequency of occurrence in the intra prediction mode list. Based on the fact that the candidate modes in the MPM list are not filled, the candidate modes in the MPM list may include intra prediction modes in the default mode set, and the default mode set may include arbitrary intra prediction modes.

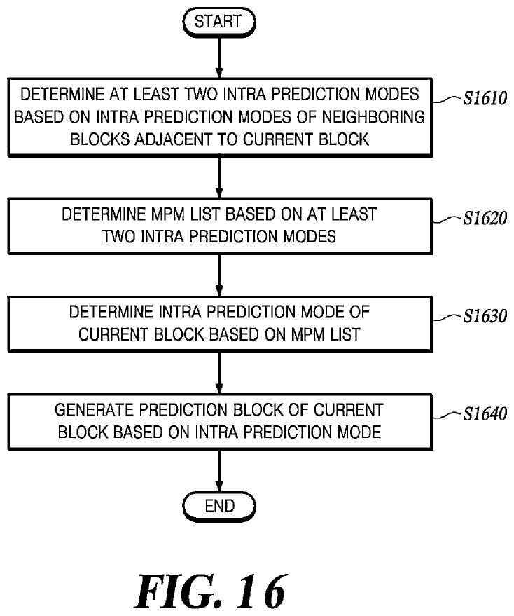

FIG. 16 is a diagram illustrating a video encoding process according to an embodiment of the present disclosure.

Referring to FIG. 16, the encoding apparatus may determine at least two intra prediction modes based on the intra prediction modes of neighboring blocks adjacent to the current block (S1610). At least two intra prediction modes may be randomly selected from the intra prediction modes of neighboring blocks adjacent to the current block. At least two intra prediction modes may be determined based on a frequency of occurrence of intra prediction modes of neighboring blocks adjacent to the current block. Also, the encoding apparatus may determine the MPM list based on at least two intra prediction modes (S1620). Candidate modes in the MPM list may be configured using an intra prediction mode list generated based on at least two intra prediction modes. The intra prediction mode list may be updated by increasing an occurrence frequency of the first intra prediction mode of the current block by one. The first intra prediction mode of the current block may be determined based on offline training. The intra prediction mode list may be generated based on a specific group to which at least two intra prediction modes belong, and the specific group may be determined based on at least one of a specific number and a specific direction of the intra prediction modes.

Also, the encoding apparatus may determine the intra prediction mode of the current block based on the MPM list (S1630). Also, the encoding apparatus may generate a prediction block of the current block based on the intra prediction mode (S1640). Candidate modes in the MPM list may include a planar mode, at least two intra prediction modes, and an intra prediction mode with a high frequency of occurrence in the intra prediction mode list. The candidate modes in the MPM list may include at least two intra prediction modes and an intra prediction mode with a high frequency of occurrence in the intra prediction mode list. The candidate modes in the MPM list may be configured in the order of the planar mode and the intra prediction modes with high frequency of occurrence in the intra prediction mode list. The candidate modes in the MPM list may be configured in the order of the intra prediction modes with high frequency of occurrence in the intra prediction mode list. Based on the fact that the candidate mode in the MPM list is not filled, the candidate modes in the MPM list may include intra prediction modes in the default mode set, and the default mode set may include arbitrary intra prediction modes.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in this specification are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which this disclosure pertains should understand that the scope of the present disclosure is not to be limited by the above explicitly described embodiments but by the claims and equivalents thereof.

### REFERENCE NUMBER

122: intra predictor
510: entropy decoder
542: intra predictor

What is claimed is:

1. A video decoding method, comprising:
determining at least two intra prediction modes based on intra prediction modes of neighboring blocks adjacent to a current block;
deriving a most probable mode (MPM) list based on the at least two intra prediction modes;
deriving an intra prediction mode of the current block based on the MPM list; and
generating a prediction block of the current block based on the intra prediction mode,
wherein candidate modes in the MPM list are configured using an intra prediction mode list generated based on the at least two intra prediction modes.

2. The video decoding method of claim 1,
wherein the at least two intra prediction modes are randomly selected from the intra prediction modes of the neighboring blocks adjacent to the current block.

3. The video decoding method of claim 1,
wherein the at least two intra prediction modes are determined based on a frequency of occurrence of the intra prediction modes of the neighboring blocks adjacent to the current block.

4. The video decoding method of claim 1,
wherein the intra prediction mode list is updated by increasing an occurrence frequency of a first intra prediction mode of the current block by one, and
wherein the first intra prediction mode of the current block is derived based on offline training.

5. The video decoding method of claim 1,
wherein the intra prediction mode list is generated based on a specific group to which the at least two intra prediction modes belong, and
wherein the specific group is determined based on at least one of a specific number and specific direction of intra prediction modes.

6. The video decoding method of claim 4,
wherein the candidate modes in the MPM list are configured in an order of a planar mode, the at least two intra prediction modes, and intra prediction modes with a high frequency of occurrence in the intra prediction mode list.

7. The video decoding method of claim 4,
wherein the candidate modes in the MPM list are configured in an order of the at least two intra prediction modes and intra prediction modes with a high frequency of occurrence in the intra prediction mode list.

8. The video decoding method of claim 4,
wherein the candidate modes in the MPM list are configured in an order of a planar mode and intra prediction modes with a high frequency of occurrence in the intra prediction mode list.

9. The video decoding method of claim 4,
wherein the candidate modes in the MPM list are configured in an order of intra prediction modes with a high frequency of occurrence in the intra prediction mode list.

10. The video decoding method of claim 9,
wherein the candidate modes in the MPM list include intra prediction modes in a default mode set based on the candidate modes in the MPM list not being filled, and
wherein the default mode set includes arbitrary intra prediction modes.

11. A video encoding method comprising:
determining at least two intra prediction modes based on intra prediction modes of neighboring blocks adjacent to a current block;
determining a most probable mode (MPM) list based on the at least two intra prediction modes;
determining an intra prediction mode of the current block based on the MPM list; and
generating a prediction block of the current block based on the intra prediction mode,
wherein candidate modes in the MPM list are configured using an intra prediction mode list generated based on the at least two intra prediction modes.

12. The video encoding method of claim 11,
wherein the at least two intra prediction modes are randomly selected from the intra prediction modes of the neighboring blocks adjacent to the current block.

13. The video encoding method of claim 11,
wherein the at least two intra prediction modes are determined based on a frequency of occurrence of the intra prediction modes of the neighboring blocks adjacent to the current block.

14. The video encoding method of claim 11,
wherein the intra prediction mode list is updated by increasing an occurrence frequency of a first intra prediction mode of the current block by one, and
wherein the first intra prediction mode of the current block is derived based on offline training.

15. The video encoding method of claim 11,
wherein the intra prediction mode list is generated based on a specific group to which the at least two intra prediction modes belong, and
wherein the specific group is determined based on at least one of a specific number and specific direction of intra prediction modes.

16. The video encoding method of claim 14,
wherein the candidate modes in the MPM list are configured in an order of a planar mode, the at least two intra prediction modes, and intra prediction modes with a high frequency of occurrence in the intra prediction mode list.

17. The video encoding method of claim 14,
wherein the candidate modes in the MPM list are configured in an order of the at least two intra prediction modes and intra prediction modes with a high frequency of occurrence in the intra prediction mode list.

18. The video encoding method of claim 14,
wherein the candidate modes in the MPM list are configured in an order of a planar mode and intra prediction modes with a high frequency of occurrence in the intra prediction mode list.

19. The video encoding method of claim 14,
wherein the candidate modes in the MPM list are configured in an order of intra prediction modes with a high frequency of occurrence in the intra prediction mode list.

20. A computer-readable recording medium storing a bit stream generated by a video encoding method, wherein the video encoding method comprises:
determining at least two intra prediction modes based on intra prediction modes of neighboring blocks adjacent to a current block;
determining a most probable mode (MPM) list based on the at least two intra prediction modes;
determining an intra prediction mode of the current block based on the MPM list; and
generating a prediction block of the current block based on the intra prediction mode,
wherein candidate modes in the MPM list are configured using an intra prediction mode list generated based on the at least two intra prediction modes.
